(19) United States
(12) Patent Application Publication
(10) Pub. No.: US 2005/0209385 A1
(43) Pub. Date: Sep. 22, 2005

(54) Electrically conductive composite

(75) Inventors: Kenichi Higashi, Sodegaura-shi (JP); Takashi Fujimoto, Sodegaura-shi (JP); Yuji Ikezawa, Nagoya-shi (JP)

Correspondence Address: FITCH, EVEN, TABIN & FLANNERY, P. O. BOX 65973, WASHINGTON, DC, 20035, US

(73) Assignee: Sumitomo Chemical Company, Limited, Tokyo (JP)

(21) Appl. No.: 11/083,307

(22) Filed: Mar. 18, 2005

(30) Foreign Application Priority Data
Mar. 22, 2004 (JP) 2004-082140

(51) Int. Cl. C08K 3/08

(52) U.S. Cl. 524/440

(57) ABSTRACT

Disclosed is an electrically conductive composite including (A) electrically conductive fibers, (B) fibrous or rod-shaped low-melting metal which has a melting point lower than that of component (A) and is free of lead, and (C) a thermoplastic resin, the electrically conductive composite including a composite fiber bundle containing component (A) and component (B), the composite fiber bundle being covered with component (C), wherein in the electrically conductive composite, the ratios of the weights of components (A), (B) and (C) to the combined weight of components (A), (B) and (C) are 50-95% by weight for component (A), 4-40% by weight for component (B) and 1-20% by weight for component (C), wherein in the electrically conductive composite, the weight ratio of component (B) to component (A) is 0.31-0.8, and wherein in the composite fiber bundle, component (B) is enclosed in a bundle of component (A).

### BACKGROUND OF THE INVENTION

1. Field of the Invention

The present invention relates to electrically conductive composites, and more particularly to electrically conductive composites comprising thermoplastic resin and electrically conductive fibers.

2. Description of the Related Art

Electrically conductive resin compositions comprising a thermoplastic resin and electrically conductive filler added thereto are used in various fields. For example, JP2002-265768A discloses a resin composition comprising polycarbonate resin, methacrylic resin and carbon fibers incorporated in the combination of the resins.

Molded articles obtained by using conventional electrically conductive compositions, however, are insufficient in electric conductivity. Particularly, such molded articles are insufficient in thermal shock resistance regarding electric conductivity. For example, the electric conductivity of those molded articles were often affected by their use under a severe environment, e.g., repetition of use under a low-temperature atmosphere and use under a high-temperature atmosphere.

### SUMMARY OF THE INVENTION

An object of the present invention is to provide electrically conductive composites having features including (i) containing electrically conductive fibers and thermoplastic resin, (ii) being superior in molding processability, and (iii) being useful as materials of molded articles having superior thermal shock resistance regarding electric conductivity.

The present invention provides an electrically conductive composite comprising components (A), (B) and (C) defined below:
component (A): electrically conductive fibers;
component (B): fibrous or rod-shaped low-melting metal which has a melting point lower than that of component (A) and is free of lead; and
component (C): a thermoplastic resin,
   the electrically conductive composite including a composite fiber bundle comprising component (A) and component (B), the composite fiber bundle being covered with component (C), wherein in the electrically conductive composite, the ratios of the weights of components (A), (B) and (C) to the combined weight of components (A), (B) and (C) are from 50 to 95% by weight for component (A), from 4 to 40% by weight for component (B) and from 1 to 20% by weight for component (C), wherein in the electrically conductive composite, the weight ratio of component (B) to component (A) is from 0.31 to 0.8, and wherein in the composite fiber bundle, component (B) is enclosed in a bundle of component (A).

Thermoplastic resin molded articles obtained by using the electrically conductive composite of the present invention are superior in electric conductivity and thermal shock resistance regarding electric conductivity, and are able to maintain superior electric conductivity even after its use under a severe environment, e.g., repetition of use under a low-temperature atmosphere and use under a high-temperature atmosphere.

### BRIEF DESCRIPTION OF THE DRAWINGS

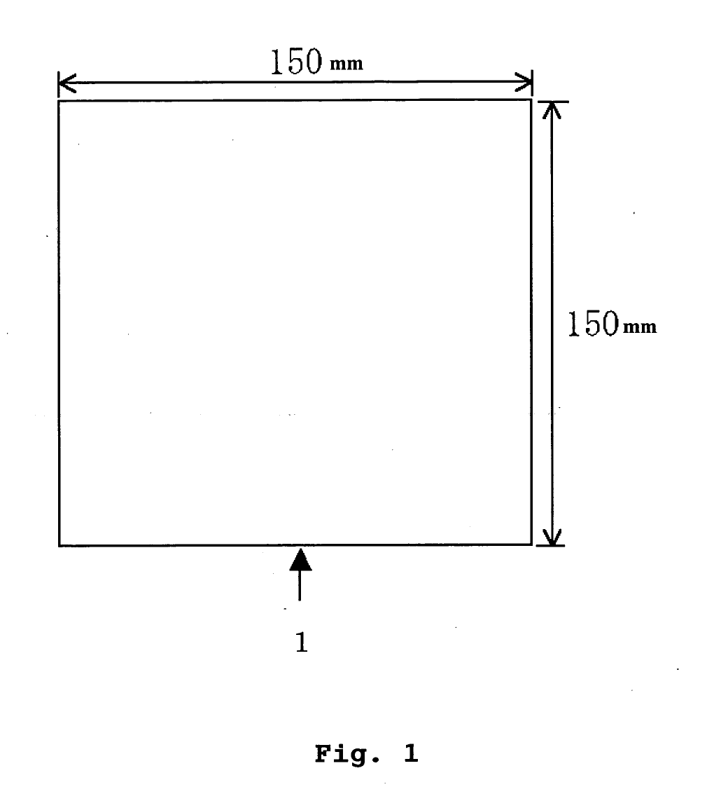

The figure (FIG. 1) is a diagram showing one of the molded articles produced in Examples of the present invention. Numeral 1 indicates the gate position.

### DESCRIPTION OF THE PREFERRED EMBODIMENTS

The electrically conductive composite of the present invention comprises components (A), (B) and (C) defined below:
component (A): electrically conductive fibers;
component (B): fibrous or rod-shaped low-melting metal which has a melting point lower than that of component (A) and is free of lead; and
component (C): a thermoplastic resin.

In the present invention, “electrically conductive fibers refer to fibers having a specific volume resistance from 10⁻⁶ Ωcm to 10⁶ Ωcm.

The electrically conductive fibers (A) are preferably metal fibers, and more preferably continuous metal fibers. Examples of the material of the electrically conductive fiber (A) include metallic materials such as metals, e.g. copper, aluminum, iron, gold, silver, nickel, titanium, tin, zinc, magnesium, platinum and beryllium, alloys, e.g. stainless steel and brass, and compounds of a metal with phosphorus. Among these metallic materials, brass, copper, aluminum, iron, gold, silver, nickel and titanium are desirably employed and copper is more desirably employed. Metal fiber can be produced by fabrication of the aforementioned metallic material into fiber by wire drawing, melt spinning, coiled material cutting, wire cutting or the like. The “continuous fiber” used herein means a fiber having a length of 1 mm or more.

Examples of the electrically conductive fibers (A) include electrically conductive, organic or inorganic fibers such as carbon fiber, non- or low-electrically conductive fibers (e.g., organic fibers such as polyester fiber and polyamide fiber and inorganic fibers such as glass fiber) having on their surface a metal layer. Examples of the method for forming the metal layer on the surface of the organic or inorganic fiber include vapor deposition, metal plating and sputtering. A method chosen appropriately depending on the type of the fiber may be used. The metal of the metal layer to be formed on the surface of the fiber preferably is, but is not limited to, copper. In the present invention, when the component (A) is electrically conductive fibers made from two or more kinds of materials, for example, fibers having a metallic surface layer such as those mentioned above, the melting point of the component (A) means the melting point lowest among the melting points of all the materials of the component (A).

The electrically conductive fibers (A) may be surface-treated with a surface treating agent such as coupling agents, e.g. silane coupling agents and titanate coupling agents, and triazine thiol compounds.

The specific volume resistance of the component (A) is desirably 10⁻³ Ωcm or less from the viewpoint of electric conductivity. The content of the component (A) in the electrically conductive composite of the present invention is 50 to 95%, preferably 55 to 90%, on the basis of the combined weight of the components (A), (B) and (C) in the electrically conductive composite. If molded articles are produced by use of an electrically conductive composite containing a too small amount of component (A), the resulting molded articles tend to have an insufficient electric conductivity. If the component (A) is too much, a poor dispersion of the electrically conductive fibers will occur during a molding process using the electrically conductive composite or using a combination of the electrically conductive composite and a thermoplastic resin and, as a result, the resulting molded articles will have an insufficient electric conductivity. In addition, if the component (A) is too much, the molding processability of the electrically conductive composite will be poor.

The cross-sectional shape of the electrically conductive fibers (A) is desirably, but is not limited to, a true or approximate circle. The electrically conductive fibers (A) preferably have an average diameter ranging from 5 to 100 μm, more preferably from 10 to 80 μm and even more preferably from 40 to 60 μm. Here, the average diameter of the electrically conductive fibers means a mean value of the diameters of circles having cross sectional areas equal to those of the fibers. If the average diameter of the fibers is within the range from 5 to 100 μm, the electrically conductive fibers have a moderate strength and the contact between the electrically conductive fibers themselves will occur efficiently when molded articles are produced by use of the electrically conductive composite or a combination of the electrically conductive composite and a thermoplastic resin. Therefore, a sufficient electric conductivity will be achieved even when a relatively small amount of the electrically conductive composite is combined with a thermoplastic resin.

The length of the electrically conductive fibers (A) is preferably from 3 to 15 mm, and more preferably from 5 to 10 mm. By setting the length of the electrically conductive fibers like this, it is possible to achieve a particularly favorable molding processability and a particularly favorable dispersibility of electrically conductive fibers and also it is possible to obtain molded articles with good appearance when producing molded articles by use of the electrically conductive composite or a combination of the electrically conductive composite and a thermoplastic resin. In addition, the electrically conductive fibers can come in contact with each other enough and, therefore, a particularly sufficient electric conductivity is achieved.

From the viewpoints of electric conductivity and thermal shock resistance regarding electric conductivity of molded articles obtained by use of the electrically conductive composite or a combination of the electrically conductive composite and a thermoplastic resin, the melting point of the low-melting metal (B) is preferably not higher than 300° C., and more preferably not higher than 250° C. Examples of the low-melting metal include alloys comprising tin, which is the main constituent, and at least one metal selected from the group consisting of silver, zinc and copper.

In the present invention, the low-melting metal (B) has a form of fiber or rod. The cross-sectional shape of the fibrous or rod-shaped low-melting metal is desirably, but is not limited to, a true or approximate circle. The fibrous or rod-shaped low-melting metal preferably has a diameter ranging from 0.01 to 5 mm, more preferably from 0.05 to 4 mm and even more preferably from 0.1 to 3 mm. Here, the diameter of the fibrous or rod-shaped low-melting metal means the diameter of a circle having a cross sectional area equal to that of the fibrous or rod-shaped low-melting metal. When the diameter of the fibrous or rod-shaped low-melting metal is within the range of from 0.01 to 5 mm, a favorable electromagnetic wave shielding characteristic can be achieved.

The length of fibrous or rod-shaped low-melting metal (B) is desirably equal to that of the electrically conductive fibers, preferably from 3 to 15 mm, and more preferably from 5 to 10 mm. Taking account only of the electromagnetic wave shielding effect, the longer the fibrous or rod-shaped low-melting metal, the better it is. However, regulating the length of the low-melting metal as stated above will result in the following merits: a good processability is achieved at the time of molding the electrically conductive composite or a combination of the electrically conductive composite and a thermoplastic resin; the appearance of the resulting molded articles and the dispersion condition of the electrically conductive fibers in the molded articles are improved; and a good electromagnetic wave shielding effect is achieved.

The low-melting metal may contain flux for the purpose of improving the weldability of the low-melting metal to the electrically conductive fibers. When flux is contained, the amount thereof is preferably from 0.1 to 5% by weight on the basis of the weight of the low-melting metal. Examples of the flux include stearic acid, lactic acid, oleic acid, glutamic acid, rosin and activated rosin.

Regarding the content of the low-melting metal in the electrically conductive composite, the ratio of the weight of the component (B) based on the combined weight of the components (A), (B) and (C) in the electrically conductive composite is preferably from 20 to 40% by weight, and more preferably from 25 to 35% by weight from the viewpoints of molding processability of the electrically conductive composite, the electric conductivity and the thermal shock resistance regarding electric conductivity of molded articles obtained by use of the electrically conductive composite or a combination of the electrically conductive composite and a thermoplastic resin.

The weight ratio of the low-melting metal (B) to the electrically conductive fibers (A) is preferably within the range from 0.31 to 0.8, and more preferably within the range from 0.32 to 0.7 from the viewpoints of molding processability of the electrically conductive composite, the electric conductivity and the thermal shock resistance regarding electric conductivity of molded articles obtained by use of the electrically conductive composite or a combination of the electrically conductive composite and a thermoplastic resin. If the weight ratio is less than 0.31, the thermal shock resistance regarding electric conductivity will become insufficient. If it is more than 0.8, the molding processability will be poor due to reduction in fluidity of the electrically conductive composite.

Examples of the thermoplastic resin (C) include polypropylene resin, polyethylene resin, polyamide resin, polyphenylene ether resin and blends or alloys composed of appropriate combinations of these resins.

Examples of the polypropylene resin include propylene homopolymer, propylene-α-olefin random copolymer and propylene-ethylene block copolymer. These may be used alone or in combination. Examples of the α-olefin include α-olefins having 2 or 4-8 carbon atoms such as ethylene, butene-1, hexene-1 and octene-1.

The thermoplastic resin (C) desirably has an MFR of not less than 10 g/10 min., but not more than 400 g/10 min. When the MFR is within the range from 10 g/10 min. to 400 g/10 min., a good dispersion of electrically conductive fibers will be achieved when molding is carried out.

Regarding the content of the thermoplastic resin (C) in the electrically conductive composite, the ratio of the weight of the component (C) based on the combined weight of the components (A), (B) and (C) in the composite is preferably from 1 to 20% by weight, and more preferably from 5 to 10% by weight. If the content of the thermoplastic resin is less than 1% by weight, electrically conductive fibers disperse insufficiently and no satisfactory electric conductivity is achieved when molded articles are produced by using the electrically conductive composite or a combination of the electrically conductive composite and the thermoplastic resin. If the content is greater than 20% by weight, the electrically conductive fibers are prevented from coming into contact with each other during the molding and no molded article having satisfactory electric conductivity is obtained.

In the electrically conductive composite of the present invention, a composite fiber bundle, in which the low-melting metal (B) is enclosed in a bundle of the electrically conductive fibers (A), is covered with the thermoplastic resin (C). In the present invention, the state where a low-melting metal (B) is enclosed in a bundle of electrically conductive fibers (A) encompasses an embodiment where the low-melting metal (B) is surrounded completely by the bundle of electrically conductive fibers (A) and also an embodiment where the low-melting metal (B) is surrounded partially by the bundle of electrically conductive fibers (A) and some portion(s) of the low-melting metal (B) are exposed.

When the electrically conductive composite is in any of the aforementioned states, it is possible to achieve a good electric conductivity and a good thermal shock resistance regarding electric conductivity of molded articles obtained by using the electrically conductive composite or a combination of the electrically conductive composite and a thermoplastic resin.

If the low-melting metal (B) remains fully excluded outside the bundle of electrically conductive fibers (A), it is impossible to obtain molded articles with good electric conductivity due to insufficient establishment of contact between the electrically conductive fibers and the low-melting metal when producing molded articles by using the electrically conductive composite or a combination of the electrically conductive composite and the thermoplastic resin.

The structure of an electrically conductive composite can be analyzed through the observation of a transverse cross section, namely, a cross section perpendicular to the longitudinal direction of the electrically conductive fibers, of the electrically conductive composite by means of a microscope or the like.

Examples of the method for the production of the electrically conductive composite of the present invention include a method comprising immersing a composite fiber bundle in molten thermoplastic resin and a method comprising feeding a composite fiber bundle and a thermoplastic resin into an extruder to melt the thermoplastic resin and then extruding them through a die. From the viewpoint of productivity, the latter method is usually chosen. The temperature of the molten thermoplastic resin at the time of the covering is preferably 20-80° C. higher and more preferably, from the viewpoint of the electric conductivity of a resulting composite, 30-70° C. higher than the melting point of the low-melting metal (B).

In the case of feeding a composite fiber bundle and a thermoplastic resin into an extruder and covering the composite fiber bundle with molten thermoplastic resin, the surface temperature of the composite fiber bundle is preferably 50 to 200° C., more preferably 100 to 200° C., and even more preferably 150 to 200° C. By using a composite fiber bundle whose surface temperature is a temperature within the aforementioned range, it is possible to obtain an electrically conductive composite having a good electric conductivity.

In usual, the composite fiber bundle covered with the thermoplastic resin is subsequently cut into an appropriate size to form pellets. The cross-sectional shape of the pellets are not particularly restricted and may be a circle, an ellipse or other shape.

The number of the electrically conductive fibers (A) contained in one composite fiber bundle is preferably less than 100 fibers, more preferably 50 to 95 fibers, and even more preferably 60 to 90 fibers from the viewpoints of dispersibility of electrically conductive fibers, electric conductivity and thermal shock resistance regarding electric conductivity of molded articles, appearance of molded articles and molding processability of an electrically conductive composite when producing molded articles using the electrically conductive composite or a combination of the electrically conductive composite and a thermoplastic resin.

The electrically conductive composite of the present invention is usually mixed with a thermoplastic resin and is molded to give molded articles. The mixing proportions of the thermoplastic resin and the electrically conductive composite are appropriately set depending on electric conductivity and so on required for the intended molded articles. The kind of the thermoplastic resin to be used is not particularly restricted and may be chosen depending on physical properties necessary for the intended molded articles. Additionally, various kinds of additives such as metal powders, inorganic fillers, antioxidants, copper inhibitors, UV absorbers and radical scavengers, thermoplastic elastomers and the like may be added.

When producing molded articles using the electrically conductive composite of the present invention or a combination of the electrically conductive composite and a thermoplastic resin, it is possible to perform the molding by a conventionally known method, such as injection molding, injection compression molding and injection press molding. It is desirable that the molding be conducted at a temperature not lower than the melting point of the low-melting metal. At the time of the molding, it is permitted to incorporate a chemical foaming agent or a physical foaming agent to perform expansion molding.

The electrically conductive composite of the present invention is superior in molding processability. The molded articles obtained from the electrically conductive composite have less defective appearance because the fibers are sufficiently opened.

Moreover, the molded articles are superior in electric conductivity and thermal shock resistance regarding electric conductive. In other words, the molded articles are superior in electromagnetic wave shielding ability and thermal shock resistance regarding electromagnetic wave shielding ability.

### EXAMPLES

The present invention is explained with reference to Examples below. The invention, however, is not limited to the Examples.

The molding of specimens to be used for evaluating electric conductivity and the evaluation of the electric conductivity were carried out in the manners described below.

(1) Injection Molding Machine, Mold and Molding Conditions

Injection machine: J150E manufactured by The Japan Steel Works, Ltd., clamping force=150 ton

Molding temperature: 250° C.

Mold: The plan view of a corresponding product is shown in FIG. 1.

Mold temperature: 40° C.

(2) Measurement of Electric Conductivity

<Measurement of Internal Resistance>

At four corners of a molded article produced using the conditions shown in (1) above, copper screws were tied at about 100-mm intervals. For each of two pairs of adjacent screws, the resistance between the two screws was measured with a milli-ohm tester. Thus, the internal resistance of the specimen was measured. The smaller the internal resistance, the better the electric conductivity.

(3) Thermal Shock Test

A thermal shock test was carried out using a thermal shock tester (manufactured by Tabai Espec Corp.).

Using test conditions including a low-temperature bath temperature of −10° C., a low-temperature exposure time of 30 min., a high-temperature bath temperature of 90° C. and a high-temperature exposure time of 25 min., 300 cycles of thermal shock were performed, each cycle having a reciprocating transfer of a sample from the low-temperature bath to the high-temperature bath and back to the low-temperature bath.

### Example 1

Sixty copper fibers having a diameter of 50 μm and one lead-free solder having a diameter of 300 μm were used as (A) electrically conductive fibers and (B) low-melting metal, respectively. A composite fiber bundle comprising (B) enclosed within a fiber bundle of (A) was extruded together with (C) polypropylene resin (propylene homopolymer, MFR 100 g/10 min., Sumitomo Noblen U501E1 manufactured by Sumitomo Chemical Co., Ltd.) through a die attached to an extruder having a cylinder 40 mm in diameter. Thus, the surface of the composite fiber bundle was covered with the polypropylene resin. Thereafter, the covered composite fiber bundle was cut into pellets 6 mm long to yield an electrically conductive composite. The resulting electrically conducting composite had a composition: 60% by weight of copper fiber, 30% by weight of lead-free solder and 10% by weight of polypropylene resin.

The resulting electrically conductive composite (31% by weight) was dry-blended with 46% by weight of a polypropylene resin composition (a composition consisting of 60% by weight of a propylene-ethylene copolymer having an MFR of 60 g/10 min., 20% by weight of an ethylene-l-octene copolymer having an MFR of 8 g/10 min. and 20% by weight of talc), 15% by weight of a propylene-ethylene copolymer (Sumitomo Noblen AZ161T, manufactured by Sumitomo Chemical Co., Ltd.; MFR 30 g/10 min.) and8% by weight of copper inhibitor master batch (Sumitomo Noblen MB109, manufactured by Sumitomo Chemical Co., Ltd.). Subsequently, the resulting blend was subjected to injection molding under conditions including a molding temperature of 250° C. and a mold temperature of 40° C. to give a molded article having a length of 150 mm, a width of 150 mm and a thickness of 2 mm. The condition of the surface of the molded article was good. The molded article was evaluated for its internal resistance and the results are shown in Table 3.

### Example 2

Ninety copper fibers having a diameter of 50 μm and one lead-free solder having a diameter of 300 μm were used as (A) electrically conductive fibers and (B) low-melting metal, respectively. A composite fiber bundle comprising (B) enclosed within a fiber bundle of (A) was extruded together with (C) polypropylene resin (propylene homopolymer, MFR 100 g/10 min., Sumitomo Noblen U501E1 manufactured by Sumitomo Chemical Co., Ltd.) through a die attached to an extruder having a cylinder 40 mm in diameter. Thus, the surface of the composite fiber bundle was covered with the polypropylene resin. Thereafter, the covered composite fiber bundle was cut into pellets 6 mm long to yield an electrically conductive composite. The resulting electrically conducting composite had a composition: 67.5% by weight of copper fiber, 22.5% by weight of lead-free solder and 10% by weight of polypropylene resin.

The resulting electrically conductive composite (30% by weight) was dry-blended with 50% by weight of a polypropylene resin composition (a composition consisting of 60% by weight of a propylene-ethylene copolymer having an MFR of 60 g/10 min., 20% by weight of an ethylene-1-octene copolymer having an MFR of 8 g/10 min. and 20% by weight of talc), 12% by weight of a propylene-ethylene copolymer (Sumitomo Noblen AZ161T, manufactured by Sumitomo Chemical Co., Ltd.; MFR 30 g/10 min.) and 8% by weight of copper inhibitor master batch (Sumitomo Noblen MB109, manufactured by Sumitomo Chemical Co., Ltd.). Subsequently, the resulting blend was subjected to injection molding under conditions including a molding temperature of 250° C. and a mold temperature of 40° C. to give a molded article having a length of 150 mm, a width of 150 mm and a thickness of 2 mm. The condition of the surface of the molded article was good. The molded article was evaluated for its internal resistance and the results are shown in Table 3.

### Comparative Example 1

One hundred and twenty copper fibers having a diameter of 50 μm and one lead-free solder having a diameter of 300 μm were used as (A) electrically conductive fibers and (B) low-melting metal, respectively. A composite fiber bundle comprising (B) enclosed within a fiber bundle of (A) was extruded together with (C) polypropylene resin (propylene homopolymer, MFR 100 g/10 min., Sumitomo Noblen U501E1 manufactured by Sumitomo Chemical Co., Ltd.) through a die attached to an extruder having a cylinder 40 mm in diameter. Thus, the surface of the composite fiber bundle was covered with the polypropylene resin. Thereafter, the covered composite fiber bundle was cut into pellets 6 mm long to yield an electrically conductive composite. The resulting electrically conducting composite had a composition: 72% by weight of copper fiber, 18% by weight of lead-free solder and 10% by weight of polypropylene resin.

The resulting electrically conductive composite (28% by weight) was dry-blended with 50% by weight of a polypropylene resin composition (a composition consisting of 60% by weight of a propylene-ethylene copolymer having an MFR of 60 g/10 min., 20% by weight of an ethylene-1-octene copolymer having an MFR of 8 g/10 min. and 20% by weight of talc), 17% by weight of a propylene-ethylene copolymer (Sumitomo Noblen AZ161T, manufactured by Sumitomo Chemical Co., Ltd.; MFR 30 g/10 min.) and 8% by weight of copper inhibitor master batch (Sumitomo Noblen MB109, manufactured by Sumitomo Chemical Co., Ltd.). Subsequently, the resulting blend was subjected to injection molding under conditions including a molding temperature of 250° C. and a mold temperature of 40° C. to give a molded article having a length of 150 mm, a width of 150 mm and a thickness of 2 mm. The condition of the surface of the molded article was good. The molded article was evaluated for its internal resistance and the results are shown in Table 3.

### Comparative Example 2

A molded article was produced in the same manner as Example 1 except using an electrically conductive composite comprising lead-free solder and copper fibers wherein the lead-free solder was not enclosed in the copper fibers and the lead-free solder and the copper fibers were adjoiningly arranged parallel to each other and were covered with a polypropylene resin. The molded article was evaluated for its internal resistance and the results are shown in Table 3. In the surface of the molded article, the occurrence of separation of the solder was observed.

### Comparative Example 3

A molded article was produced by injection molding in the same manner as Example 1 except using 22% by weight of a 6-mm long electrically conductive composition comprising 91 copper fibers having a diameter of 50 μm covered with a propylene homopolymer (MFR 100 g/10 min.), 35% by weight of a resin composition composed of 20% by weight of lead-free solder having a composition Sn/Cu/Ag=96.5/0.5/3 (weight ratio) and 80% by weight of a polypropylene resin composition (a composition composed of 60% by weight of a propylene-ethylene copolymer having an MFR of 60g/10 min. 20% by weight of an ethylene-1-octene copolymer having an MFR of 8 g/10 min., and 20% by weight of talc), 36% by weight of a polypropylene resin composition (a composition composed of 60% by weight of a propylene-ethylene copolymer having an MFR of 60 g/10 min., 20% by weight of an ethylene-1-octene copolymer having an MFR of 8,g/10 min., and 20% by weight of talc), and 8% by weight of a copper inhibitor master batch (Sumitomo Noblen MB109, manufactured by Sumitomo Chemical Co., Ltd.). The condition of the surface of the molded article was good. The molded article was evaluated for its internal resistance and the results are shown in Table 3.

### Comparative Example 4

A molded article containing 31.2% by weight of copper fibers and 6.5% by weight of lead-free solder was obtained in the same manner as Comparative Example 3 except using a 6-mm long electrically conductive composition comprising a bundle of 640 copper fibers having a diameter of 50 μm covered with a propylene homopolymer having an MFR 100 g/10 min. The condition of the surface of the molded article was good. The molded article was evaluated for its internal resistance and the results are shown in Table 3.

TABLE 1

Example

| | | 1 | 2 |
|---|---|---|---|
| Electrically | Metal Fiber | 60 wt % | 67.5 wt % |
| Conductive | Low-Melting | 30 wt % | 22.5 wt % |
| Composite | Metal | | |
| | Thermoplastic | 10 wt % | 10 wt % |
| | Resin | | |
| | Low-Melting | 0.5 | 0.33 |
| | Metal/Metal | | |
| | Fiber | | |
| | Weight Ratio | | |
| | Structure* | A | A |
| Molded | Metal Fiber | 19.8 wt % | 20.25 wt % |
| Article | Low-Melting | 9.9 wt % | 6.75 wt % |
| | Metal | | |
| | PP | 42.3 wt % | 45 wt % |
| | Elastomer | 10 wt % | 10 wt % |
| | Talc | 10 wt % | 10 wt % |
| | Copper | 8 wt % | 8 wt % |
| | Inhibitor | | |

Structure*
A: The metal fiber bundle encloses the low-melting metal therein and is covered with a resin.

TABLE 2

| | | Comparative Example | | | |
|---|---|---|---|---|---|
| | | 1 | 2 | 3 | |
| Electrically | Metal Fiber | 72 wt % | 60 wt % | 90 wt % | 0 |
| Conductive | Low-Melting | 18 wt % | 30 wt % | 0 | 20 wt % |
| Composite | Metal | | | | |
| | Thermoplastic | 10 wt % | 10 wt % | 10 wt % | 80 wt % |
| | Resin | | | | |

| | | | | |
|---|---|---|---|---|
| | Low-Melting | 0.25 | 0.5 | 0.38 |
| | Metal/Metal | | | |
| | Fiber | | | |
| | Weight Ratio | | | |
| | Structure* | A | B | C |
| Molded | Metal Fiber | 20.16 wt % | 19.8 wt % | 19.8 wt % |
| Article | Low-Melting | 5.04 wt % | 9.9 wt % | 7.5 wt % |
| | Metal | | | |
| | PP | 46.8 wt % | 42.3 wt % | 44.7 wt % |
| | Elastomer | 10 wt % | 10 wt % | 10 wt % |
| | Talc | 10 wt % | 10 wt % | 10 wt % |
| | Copper | 8 wt % | 8 wt % | 8 wt % |
| | Inhibitor | | | |

Structure*
A: The metal fiber bundle encloses the low-melting metal therein and is covered with a resin.
B: The low-melting metal and the metal fiber bundle are adjoiningly arranged parallel to each other and are covered with resin.
C: A low-melting metal/PP composite and a metal fibers/PP composite are combined.

TABLE 3

| | | | | Comparative | | |
|---|---|---|---|---|---|---|
| | | Example | | Example | | |
| | | 1 | 2 | 1 | 2 | 3 |
| Electric | Initial | 0.008 | 0.032 | 0.071 | 0.008 | 0.009 |
| Conductivity | After Thermal | 0.036 | 0.050 | 8.000 | 0.080 | 0.060 |
| (Ω) | Shock Test | | | | | |

1. An electrically conductive composite comprising components (A), (B) and (C) defined below:
component (A): electrically conductive fibers;
component (B): fibrous or rod-shaped low-melting metal which has a melting point lower than that of component (A) and is free of lead; and
component (C): a thermoplastic resin.
the electrically conductive composite including a composite fiber bundle comprising component (A) and component (B), the composite fiber bundle being covered with component (C), wherein in the electrically conductive composite, the ratios of the weights of components (A), (B) and (C) to the combined weight of components (A), (B) and (C) are from 50 to 95% by weight for component (A), from 4 to 40% by weight for component (B) and from 1 to 20% by weight for component (C), wherein in the electrically conductive composite, the weight ratio of component (B) to component (A) is from 0.31 to 0.8, and wherein in the composite fiber bundle, component (B) is enclosed in a bundle of component (A).

2. The electrically conductive composite according to claim 1, wherein the electrically conductive fibers (A) are copper fibers.
